(19) United States
(12) Patent Application Publication
(10) Pub. No.: US 2014/0167415 A1
(43) Pub. Date: Jun. 19, 2014

(54) METHOD OF WIND TURBINE YAW ANGLE CONTROL AND WIND TURBINE

(71) Applicant: MITA-TEKNIK A/S, Rodkaersbro (DK)

(72) Inventor: Viktor Mykhaylyshyn, Lviv (UA)

(73) Assignee: MITA-TEKNIK A/S, Rodkaersbro (DK)

(21) Appl. No.: 14/083,520

(22) Filed: Nov. 19, 2013

(30) Foreign Application Priority Data
May 19, 2011 (UA) A201106319
Dec. 27, 2011 (UA) PCT/UA2011/000130

(51) Int. Cl. F03D 7/02; F03D 9/00

(52) U.S. Cl. CPC F03D 7/0204; F03D 9/002
USPC 290/44

(57) ABSTRACT

The present invention relates to the wind power engineering and to the method of controlling a yaw angle of the wind turbine, equipped with a horizontal rotor shaft as well as to the wind turbine for implementing the method. According to the method of the present invention, the time difference between the time moments when the rotor blades are in the lower vertical position, the said time moments derived from the reference signal of the sensor connected to the rotor shaft, and the time moments when the blades are on one line with the wind direction and the tower, the said time moments_derived from the periodic signal of the spurious amplitude modulation generated by the AC generator and caused by aerodynamic interaction between the blades and the tower, is used as the indication of actual position of the wind turbine rotor relative to the wind direction. The wind turbine of the present invention comprises a yaw controller including the functional units suitable for generating a control signal for rotating a nacelle of wind turbine based on the given time difference in order to compensate the existing yaw error.

### RELATED APPLICATIONS

This application claims priority to Patent Cooperation Treaty Application number PCT/UA2011/000130, filed on Dec. 27, 2011, which claims priority to Ukrainian patent application number a201106319, filed on May 19, 2011 and incorporated herewith by reference in its entirety.

### FIELD OF THE INVENTION

The present invention relates to the wind power engineering and to the method of wind turbine yaw angle control, the said wind turbine being equipped with a horizontal rotor shaft, as well as to the wind turbine, being controlled by such a method.

### BACKGROUND OF THE INVENTION

Wind power engineering is the most dynamically developed among the most perspective directions of using the renewable energy sources and has already become a competitive player on the market of electric energy generation.

The overwhelming majority of the modern wind turbines (WTs) have a three-bladed rotor with a horizontal rotor shaft. Such turbines require a certain mechanism for directing a rotor to the wind and respective yaw controller. A yaw control error is determined as an angle between the actual direction of a rotor shaft and wind direction. In order to achieve a maximal conversion of the kinetic wind energy, a yaw control error of a wind turbine (WT) is to be zero.

In the process of yaw control, a nacelle of wind turbine (WT) is being rotated around the vertical axis to minimize a yaw control error. The wind turbine (WT) tower axis usually coincides with the rotation axis of a nacelle. The yaw direction is physically controlled by the electrical or hydraulic wind turbine (WT) yaw drives.

According to the prior art, a system of a typical modern wind turbine (WT) yaw angle control is based on a direct measuring of a wind direction by one or more electromechanical (analogous) or optical (discrete) direction sensors: anemometer wind vanes placed on the aft of a wind turbine nacelle.

The imperfection of the usual electromechanical and optical sensors (anemometer wind vanes), their location on the nacelle behind the turbine rotor, the necessity to calibrate them during wind turbine (WT) commissioning practically almost always cause inaccurate yawing of a usual wind turbine (WT). The accuracy of measuring wind direction by means of anemometer wind vanes located on a wind turbine (WT) nacelle behind the turbulent air flow, generated by the rotor, is non-satisfying in most cases. The measurement error is a function of wind velocity, turbulence intensity, wind direction and other parameters of wind flow moving through a wind turbine (WT) rotor and of the rotor aerodynamic characteristics.

The yaw control errors of the wind turbine (WT) electromechanical anemometer wind vanes placed on a nacelle behind a rotor usually range within ±15°, the said errors being caused by the not characteristic evaluations of wind direction. At the same time, the standard error deviation is 5°.

US 2009/0039651 A1 <<Method for wind turbine yaw control>> published on Apr. 4, 2010 notes that it is very difficult to achieve an ambiguity of wind direction ranging within ±5° for an electromechanical anemometer wind vanes located on the aft of a nacelle considering all sources of measurement ambiguity.

The requirements of the modern wind power industry promote scientific developments concerning measurements of the wind parameters based on the ultrasonic technologies (see T. F. Pedersen, N. S. Sørensen, Luca Vita, Peder Enevoldsen, Optimization of Wind Turbine Operation by Use of Spinner Anemometer ris-r-1654).

The experimental studies of the wind turbine (WT) power losses (Pedersen T F, “On Wind Turbine Power Performance Measurements at Inclined Airflow”, WIND ENERGY 2004; 7:163-176) show a reduction in the wind turbine (WT) output power as a function of “squared cosine of a yaw angle error”. In practice, this means a reduction in power by 1%, 3%, 7% and 22% for a systematic average yaw angle error of 5°, 10°, 15° and 20°, respectively.

A yaw angle error for a 3.6 MW wind turbine measured by an ultrasonic wind meter on the rotor spinner is approximately 10°. This means that a significant increase in power and respectively produced energy can be achieved by optimizing the yaw control process.

Assuming that the average yaw angle error of wind turbine is 8° and standard deviation is 2°, the power losses will be 3.8% as compared to the correct yaw angle of a rotor of wind turbine. After a yaw angle error has been corrected to be equal to the average value of 0° with standard deviation of 2° the power losses will be 1.9%. Thus, an optimization of an error will lead to an increase in the wind turbine output power by 1.9%.

A yaw angle error has a greater scattering and output power is more sensitive to a yaw angle error when the wind velocities are low and moderate. The sharp changes of a wind direction typical for these conditions cause variations of the wind turbine (WT) output power and the additional dynamic load on the mechanical drive train. Of course, they are undesired phenomenon as they can cause a significant reduction in the fatigue durability of the construction and of the wind turbine (WT) drive train components (US patent application No. 20080111379 published on May 15, 2008 “Wind Turbine and Method for the Automatic Correction of Wind Vane Settings” Altemark, J.)

A comparison of the yaw angle measured by a wind vane to this of the ultrasonic wind meter located on the rotor spinner reveal the yaw angle error in the wind vane measurement approximately 20%.

Laser devices based on the Doppler Effect are also being introduced into the wind power industry.

For example, the last generation Vindicator® type laser wind sensor (LWS) (http://www.catchthewindinc.com/products/vindicator-turbine-control) is placed on the wind turbine (WT) nacelle. In this location, the sensor allows determination of the velocity and direction of the undisturbed wind flow in front of the turbine rotor at a distance of up to 300 m. As a result, the control system of wind turbine (WT) receives more reliable data of the wind conditions which allows optimization of the wind turbine (WT) efficiency.

Of course, the new developments allow measuring the wind flow parameters in more accurate way compared to the traditional wind turbine wind meters. Therefore, the ultrasonic anemometer installed on the rotor spinner senses already undisturbed wind flow that falls directly on the rotor. However, the nature of measurements still remains local. The laser wind sensors also have significant advantages over the existing system for measuring wind parameters. However, they still remain on the stage of the research engineering developments. The mass use of such devices now and in the nearest future is unlikely as the retrofitting of the parks based on the proposed new technological solutions incurs significant expenses. Integration of the laser wind sensors may also require substantial changes of the existing wind turbine controllers' firmware.

Meantime, the actual data of the measurement of a yaw angle error carried out by the 2 MW wind turbine controller is often as that of FIG. 2. This data is received from the wind turbine installed in China.

The wind turbine was in a non-optimal position during almost 3 minutes and had the average yaw angle error of about 13.5° and standard deviation of 2.6°. Usually, in the similar cases, it is necessary to optimize the yaw control system which will provide a significant increase in the produced electric energy without additional financial expenses.

The closest prior art for the present invention is US 20100054941 dated Mar. 4, 2010 (“Wind tracking system of a wind turbine>>) describing the yaw control system of the wind turbine that works on the basis of the additional sensor receiving a torsion moment of the wind turbine nacelle or bending moment to which the rotor shaft is subjected when deviating from the correct direction on the wind.

The modern resistance strain gauges of torsion or bending moment allow measuring the necessary mechanical value with the required precision and obtain it as an electrical signal both in the analogous and digital forms. However, the difficulties of the practical implementation of such invention can be experienced when retrofitting the active wind turbines under the operating conditions. The wind turbine should be stopped for such operations; the conditions of mounting the additional resistance strain gauges significantly differ from those of assembling the wind turbine on the factory; there might be no direct access to the places where the sensor should be installed. It may be necessary to obtain permission from the wind turbine manufacturer and insurance company in order to retrofit it. Also resistance strain gauges require periodical inspection and the long time operation under the severe conditions can affect the efficiency and accuracy of such tracking system.

Therefore, the aim of the invention is creation of a wind turbine yaw control method and a device, implementing such a method, which, by using generated alternate current components, unambiguously indicating yaw error, ensure growth of WT effectiveness due to increased precision in rotor shaft yawing to the wind.

### SUMMARY OF THE INVENTION

In the method part, the problem is solved by controlling a yaw angle of the wind turbine, containing a rotatable around a vertical axis nacelle, mounted on a stationary tower and containing a horizontal rotating rotor shaft, the rotor formed by at least two blades transforming the kinetic energy of the wind into the rotational movement of the rotor shaft, mechanically connected to the electric generator, producing an electrical signal, which depends on the deviation of the rotor shaft axis from the wind direction and is processed by the yaw controller; based on the processed signal the feedback control signal is generated and sent to the yaw actuator until elimination of the yaw error is achieved. According to the invention, to the yaw actuator a control signal is sent, formed based on the time difference between the moments of time when the rotor blades are in the lower vertical position, which are determined using a reference signal of a sensor connected to the rotor shaft and the moments of time, when the rotor blades are on one line with the wind direction and the tower, determined based on the spurious amplitude modulation periodic signal, generated by the AC electric generator and caused by aerodynamic interaction between the blades and the tower. In the preferred embodiment of the present invention, the time moments when the blades are in the lower vertical position are obtained from the vector signal of the rotor position sensor, fixed on the rotor shaft in the plane perpendicular to the rotor axis and offset relative to the centre of the rotor, one of the sensitivity axes of the sensor aligned with that of the blade. The said signal can be also generated by means of a magnetic encoder equipped with a magnetic scale in the form of a ring or strip fixed on the rotor shaft, by means of photo-optic pulse encoder provided with a transparent disk scale fixed on the rotor shaft, by means of contactless induction proximity sensor and gear wheel fixed on the rotor shaft or by means of a system for determining a position of the wind turbine rotor blade using a wireless signal transmission, comprising a transmitter mounted on the wind turbine rotor blade, a receiver and a calculating device for determining a rotor position.

According to the present invention, a periodic signal of an aerodynamic interaction between the rotor blades and the tower is obtained by carrying out the following sequence of actions: forming an envelope of AC current generated by the electric generator by means of amplitude demodulation of a current signal in the vicinity of the grid frequency; evaluating a period and Fourier coefficients of the periodic component of the obtained envelope and isolating a fundamental harmonic of an aerodynamic interaction between the rotor blades and the tower signal.

The said time difference is determined as a phase difference between the reference signal of the rotor position sensor and the fundamental harmonic of the aerodynamic interaction between the rotor blades and the tower periodic signal.

A time difference signal is low pass filtered to remove the high frequency components before being sent to a yaw actuator control module. The filtered time difference signal is sent to the input of the yaw actuator control module designed as P controller, PI controller, PID controller, neural-network controller, fuzzy logic controller, adaptive Kalman filter or look-up table for matching with the dynamic parameters of the structural components of a wind turbine and its environment, and where the control signal is generated for the yaw actuator.

The problem is also solved by the wind turbine for implementing the method according to the present invention, the said wind turbine comprising a nacelle mounted on the stationary tower and rotatable around the vertical axis, the rotor shaft placed in the nacelle and rotatable around the horizontal axis, the rotor of the wind turbine formed by at least two blades mounted on the shaft and transforming the kinetic energy of the wind into the rotational movement of the rotor shaft, the electric generator mechanically connected to the rotor shaft, the yaw controller the output of which is connected to the yaw actuator.

According to the present invention, the wind turbine contains a connected to the rotor shaft reference signal sensor, indicating the lower vertical position of the rotor blades and a connected to the reference signal sensor and to the electrical generator, yaw controller, which can generate a control signal based on the time difference between the moments when the blades are in the lower vertical position and when they are on one line with the tower and wind direction.

In the preferred embodiment of the wind turbine, the yaw controller comprises the following functional units: the generator signal envelope builder; the aerodynamic interaction between the rotor blades and the tower periodic signal fundamental harmonic filter, connected to the output of the builder; the reference signal processing module, connected to the sensor; the phase meter connected to the outputs of the reference signal processing module and of the aerodynamic interaction between the rotor blades and the tower periodic signal fundamental harmonic filter; the time difference signal low pass filter and the yaw actuator control module designed as P controller, PI controller, PID controller, neural-network controller, fuzzy logic controller, adaptive Kalman filter or look-up table and connected to the output of the low pass filter, the output of the said module being connected to the yaw actuator.

### BRIEF DESCRIPTION OF THE DRAWINGS

The present invention is explained below in more details with reference to the drawings, in which:

FIG. 1 Is a sketch of the wind turbine top view;

FIG. 2 Is the wind turbine yaw control errors based on the measurements of the wind vane mounted on the nacelle of the wind turbine Taiyuan Heavy Industry 2 MW, China;

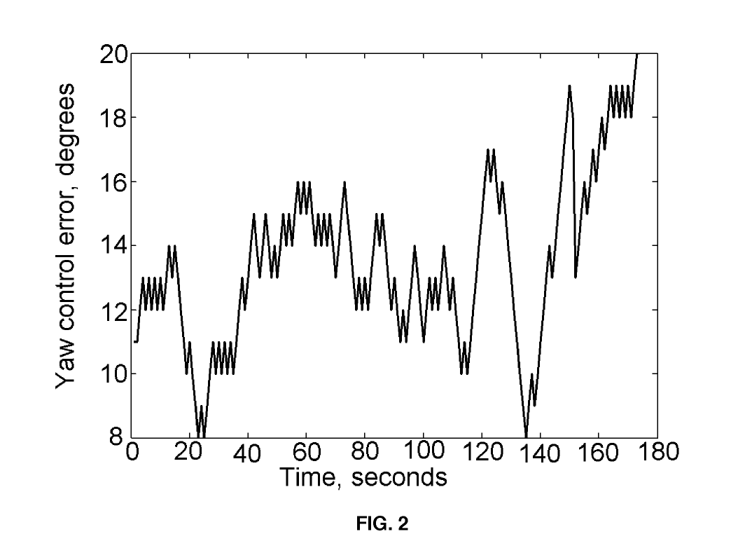

FIG. 3 Is a plot of the current signal envelope during six turns of the rotor;

FIG. 4 Is the wind turbine correctly directed to the wind;

FIG. 5 Shows the wind blowing mostly on the left side of the wind turbine nacelle;

FIG. 6 Is a flow chart of the wind turbine yaw angle control system.

### DETAILED DESCRIPTION OF THE PREFERRED EMBODIMENT

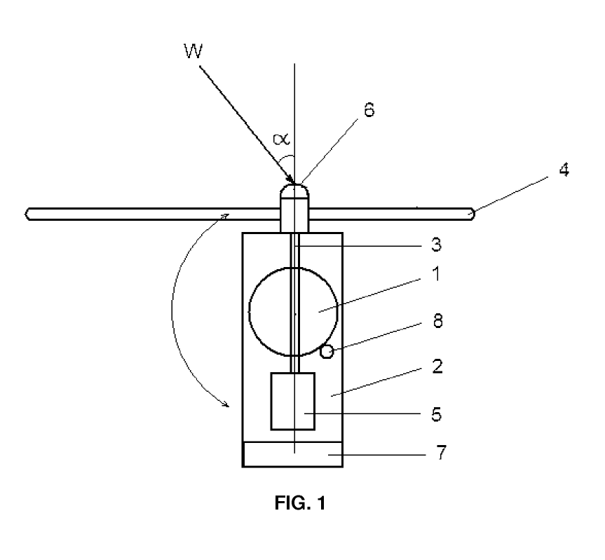

FIG. 1 shows schematically the wind turbine according to the present invention intended for implementing the method according to the present invention, the said wind turbine comprising the tower 1, on which the rotatable around the vertical axis nacelle 2 is mounted and the rotor shaft 3, rotatable around the horizontal axis and formed by three blades 4 intended for transforming the wind energy into the rotational movement of the rotor shaft in the described embodiment of the invention is installed in the nacelle 2. Generally, the rotor shaft axis deviates from the wind direction W by angle a. The electric generator 5 is mechanically connected to the rotor shaft 3. In order to control the yaw angle of the rotor, the wind turbine is equipped with the blades position sensor 6 with yaw controller 7 and with the nacelle yaw drive 2 (yaw actuator 8) integrated in the closed loop automated control.

The WT rotor yaw control method is based on the contactless measurement of the current parameters of the wind turbine induction generator. The ideal electrical current signal of the generator phase is a sinusoidal oscillation of constant frequency of 50 Hz (or 60 Hz) and of certain amplitude.

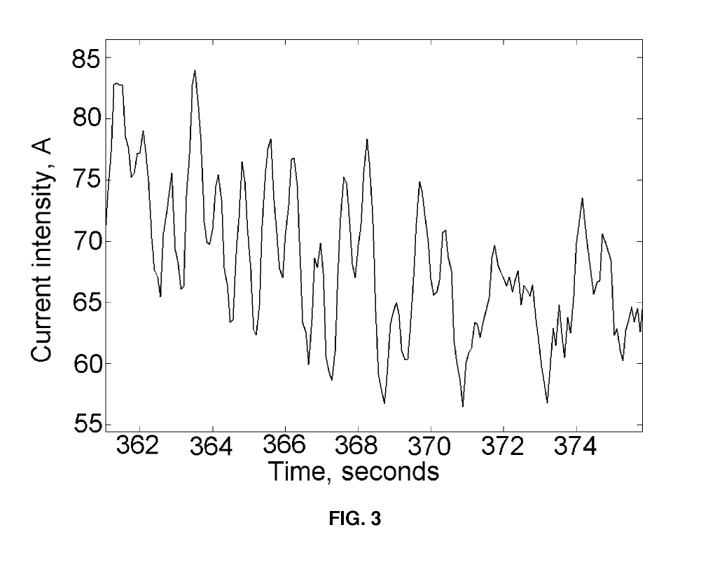

However, the actual current signal of one phase of the wind turbine generator equipped with three blades has more complicated form shown in FIG. 3.

FIG. 3 shows the envelope of the induction generator phase current signal within the time range of approximately six turns of the rotor. The envelope constitutes the instant values of the alternate current amplitude of the 50 Hz frequency. It can be visually observed that the envelope comprises slow and fast oscillation components. The slow oscillation components are related to continuous changes of the wind parameters (its velocity and direction, turbulence) and the fast components are generally generated by the eigen bending and torsion oscillations of the tower, by rotor rotation, by the eigen longitudinal and transverse oscillations of the blades and by their higher harmonics. The said fluctuations of the current are spurious and completely undesirable for the consumer with regard to the generated electrical power quality. The slow components of the spurious oscillations do not include useful information for the present invention. The relatively high frequency components mostly generated by the movement of the rotor blades in the turbulent wind flow are of interest. The component of frequency 1p corresponding to the rotational speed of the rotor appears in the spectrum if there is a mechanical imbalance of the rotor or if the rotor blades differ one from another due to the established angle of attack (pitch), to the damage, contamination or icing of the surfaces. Harmonics of frequency 2p can appear as a result of non-linear interaction in the rotating rotor system.

If the rotor comprises three blades, then the component of frequency 3p appears due to the aerodynamic interaction between the blades and the tower of the wind turbine. When each of the blades passes by the tower, the layer of air between them is compressed and the blade is subjected to the elastic impact of this aerodynamic pulse causing a pulse irregularity of the rotor shaft rotation and generation of the electrical pulse applied to the power produced by the generator, respectively.

Having analyzed the spectral decomposition of the generator current as well as the time correlation between the parameters of this current and wind turbine rotor parameters and operating conditions, it has been established that the signal caused by an interaction between the blade and the tower is formed at the time moment when the blade is on one line with the wind direction and the tower (so called “effect of aerodynamic tower shadow”).

The amplitude of this pulse, its duration and form depend on the rotational speed of the rotor, on the wind velocity and turbulence intensity. The vertical gradient of the wind velocity on the ground-level layer also contributes to the component of frequency 3p and to its higher harmonics but to the lesser extent.

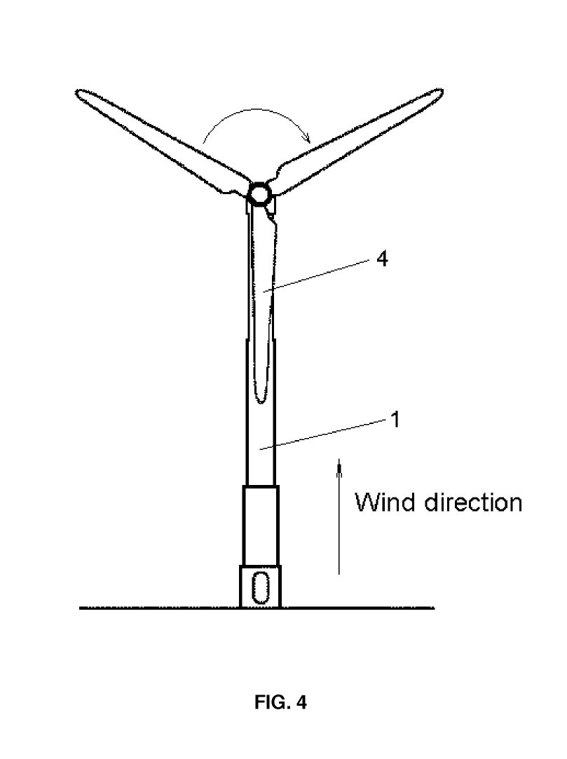

If the wind turbine is correctly directed to the wind, then the local minimum values of the current envelope corresponding to the “tower shadow” are located on the time axis at the points when the rotor blades pass the lower vertical position that can be detected by the signal of the rotor blade position sensor (FIG. 4).

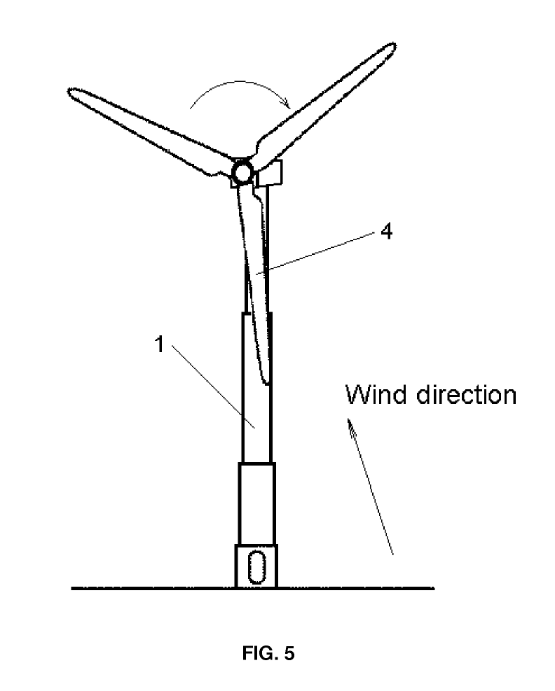

If there is a yaw control error (for example, the wind turbine exposes the left side of the nacelle to the wind), then a situation occurs when the blade has not achieved the lower vertical position yet but an aerodynamic interaction between the blade and the tower (“tower shadow”) has already occurred (FIG. 5). The spurious “tower shadow” signal in the generator signal will appear earlier as compared to the reference signal. Otherwise, when the wind is directed mostly to the right side of the nacelle of the wind turbine, then “tower shadow” appears after the moment of passing of the blade the lower vertical position. Correspondingly, the spurious “tower shadow” signal in the generator signal will appear later compared to the reference signal.

The “tower shadow” effect produces a periodic function with the main period T=1/(3p) (3p is the frequency of an event occurring three times per one turn of the three-bladed rotor). The oscillation of the generator phase current instant value can be observed on the time axis in the envelope signal (FIG. 3).

According to the present invention, a passage of the wind turbine “tower shadow” by the rotor blade is detected by means of the current signal envelope analysis at the output of the electric generator. The current signal is band-pass filtered by means of linear 4-order Butterworth recursive filter having central frequency fo=50 Hz and the bandwidth of 15 Hz. The output signal of the band-pass filter is then sent to the input of the Hilbert converter digital filter which produces an analytical complex signal. The envelope of the current signal is obtained by calculating the magnitude (absolute value) of the analytical complex signal. The periodic signal of an aerodynamic interaction between the rotor blade and the tower is obtained from the isolated envelope of the current signal by evaluating the period and calculating the Fourier coefficient estimates of the hidden periodic components in the envelope signal.

The yaw control system is equipped with the sensor of the rotating rotor blades angular position for implementing the method according to the present invention. The rotor blades position sensor generates a periodic reference signal, synchronized with the lower vertical position of the blades with the rotor rotation period equal to lip. The reference signal of frequency 3p is formed from the reference signal 1p and the phase difference between the reference signal and envelope signal (“tower shadow” signal) is determined.

According to the present invention, the reference sensor of the rotor blades angular position can be designed in several different forms.

The rotor position sensor can be traditionally produced as the known prior art induction proximity sensor (proximity probe) of the wind turbine rotor rotational speed measurement system.

The operation of the induction proximity sensor is based on the principle of the generator harmonic oscillations amplitude modulation. The main part consists of the sinusoidal oscillations generator and a sensitive electromagnetic sensor system designed as an induction coil in the core. The two-winding assembly of the inductive sensor sensitive head in the cup-like core is the most widespread. The parameters of the induction coils and of the generator components are selected so that the stable oscillations of the given frequency are excited and maintained when voltage within a wide range (10 . . . 30 V) is supplied. The core of the sensor sensitive head provides the given electromagnetic field configuration in the space near its active surface. If a metal object appears in the area of electromagnetic field of the sensor head, the eddy currents are induced in the object. The generator oscillations amplitude is decreased as the distance to the metal object decreases due to the losses caused by the mutual induction. The signal is sent from the generator to the amplitude detector and the demodulated analogue signal then comes to the builder of the rectangular pulses that provides a binary signal. The nulls are present when the amplitude of the generator oscillations decreases below the predetermined threshold and ones are present in other case. If there are massive metal tags (for example, fastening bolts or toothed ring) regularly arranged on the contour of the shaft, then the induction proximity sensor will generate a sequence of the rectangular pulses when the shaft is rotated. The time moments when the blades are in the lower vertical position and the rotational speed of the wind turbine rotor can be easily determined having set a special mark corresponding to the lower vertical position of the rotor blade based on the pulse sequence at the sensor output. The reference signal processing module adjusted to receive the pulse signals of the induction proximity sensor performs the required operations.

The sensor of the rotor shaft rotation angle may be designed as an encoder transforming the rotor shaft rotation angle into an analogue or discrete electrical signal. There are incremental and absolute encoders.

An incremental encoder generates a fixed number of the electrical pulses per one turn of the shaft. The encoder also has a digital input of zero mark allowing determination of the wind turbine rotor shaft absolute angular position. The instant angle of rotation is determined by calculating a number of pulses from the moment of passing the starting mark. To determine the shaft angular speed the processor in the reference signal processing module differentiates the number of signals with respect to time, thus obtaining the rotational speed.

An absolute encoder outputs a unique code for each angular position of the shaft. Unlike in the incremental encoder, the pulse counter is not required as the angle of rotation can always be determined by polling the encoder.

The encoders can be identified as mechanical, optical, resistive, capacitive, magnetic etc. based on the physical principle of operation. They use the standard interfaces for data communication.

According to the encoder principle of operation, the sensor of the wind turbine rotor rotation angle can be designed as a photo-pulse encoder. The principle of operation of the photo-pulse rotation angle sensor is based on the photo-electron scanning of the code track applied to the transparent disc attached to the shaft. IR radiation of the light diodes passes through the transparent disc with the code track to the receivers of photodiodes. The absolute encoder provides a unique code for each angular position of the disc (a combination of the logical nulls and ones). In the incremental encoder all marks are identical and uniformly distributed over the disc. It is advisable to place the zero mark (reference point of the reference system) in such position of the rotor shaft when one of the blades is in the lower vertical position in order to implement the present invention. The absolute photo-pulse encoders as well as the incremental encoders read and hold the parameters of the optical disc rotation.

The wind turbine rotor rotation angle sensor can be designed as a magnetic encoder registering a passage of the magnetic measuring tape magnetic poles, designed as a ring or strip fixed on the shaft, immediately beside the sensitive element. The sensor of the rotation angle generates a respective digital code at its output. The reference signal processing unit polls the sensor and determines the time moment, when the rotor blade passes the vertical position.

The rotor shaft rotation angle and its rotational speed are measured by the above-mentioned sensors inside the nacelle of the wind turbine on the slow rotor shaft in the local coordinate system, i.e., relative to the top of the turbine tower. This can cause the errors in measurement of the rotor movement parameters when the top of the tower oscillates.

In the preferred embodiment of the method according to the present invention, the parameters of the wind turbine rotor rotation are measured based on the two-axis accelerometer.

Additionally the instant value of alternating current amplitude periodical component one of the generator phases, caused by the “tower shadow” effect evaluation could be more precise using the sensor of the rotor angular position and its rotational speed by means of re-sampling of the envelope signal with regard to the rotational speed variation data.

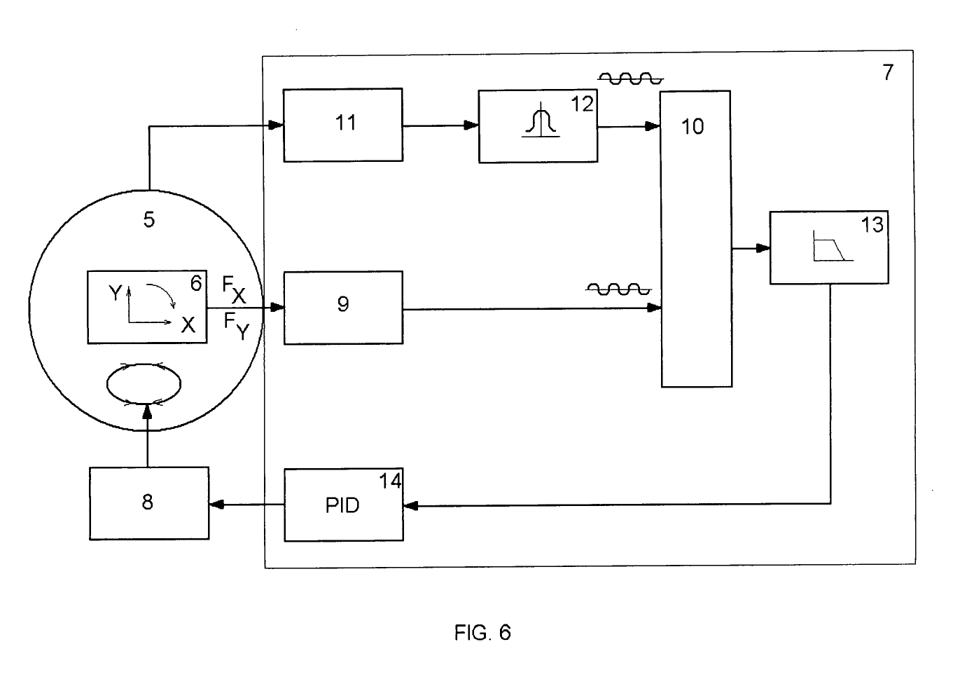

Two-axis acceleration sensor enables measuring the effective centrifugal force Fx along the X axis and effective centrifugal force Fy along the perpendicular Y axis (FIG. 6).

The acceleration sensor, attached near the rotor axis, is rotated with it and the directing vectors of the sensitive axis are also synchronously rotated. Consequently, the effective centrifugal forces Fx, Fy values oscillate between the maximum value when the vectors of the acting centrifugal forces F′x, F′y are directed vertically downward and minimum value when the vectors of the acting centrifugal forces F′x, F′y are directed vertically upward.

Based on the signals Fx, Fy the reference signal processing module generates parameters of the rotor angular position and, if necessary, the instant rotational speed value.

The reference signal processing module can be designed, for example, as an analogue circuit for the phase lock loop (PLL) or as a digital signal processor at the output of which an angular position of the rotor and an angular frequency are obtained.

The advantage of such reference signal sensor is that there is no error caused by deviation of the tower from the vertical position under the wind gusts as the reference signal is formed using the gravity force having a constant direction, not the position of the blades relative to the tower.

FIG. 6 shows the flow chart explaining how the wind turbine yaw angle is controlled by the method according to the present invention with reference to the significant functional units of the wind turbine corresponding to the present invention. Based on the blades position sensor 6 signal, the reference signal processing module 9 generates the harmonic reference signal containing the data regarding time moments when the blades pass the lower vertical position, which is fed to the input of phase meter 10. The “tower shadow” signal generated using the current of generator 5 in the envelope builder 11 and in the aerodynamic interaction between the rotor blades and the tower fundamental harmonic signal filter 12 is fed to the second input of phase meter 10. The phase difference signal corresponding to the time difference between the time moments when the blades are in the lower vertical position and the time moments when the blades are on one line with the wind direction and the tower, obtained at the output of phase meter 10, is sent to the low pass filter 13 and from the low pass filter 13 output to the yaw control actuator module 14 input. The control signal from the module 14 output is sent to the yaw actuator 8, which rotates the nacelle 2 according to the sign and value of the control signal, eliminating the error of the wind turbine rotor alignment to the wind.

The design and parameters of the low pass filter 13 and of the actuator control module are selected depending on the above-mentioned environmental dynamic parameters and parameters of the wind turbine itself. The dynamics of the wind flow parameters and yaw actuator parameters are crucial. The wind flow velocities are known to change and this affects controllability of wind turbine along the azimuth (yaw control system becomes less effective at very low velocities); the wind direction sensor always supplies inaccurate and noisy data of direction. Moreover, the drive train dynamics (type of electric machines, gearbox transmission ratios, rotational speed and torque) of wind turbine affects the system's ability to rapidly redirect the nacelle to the wind and to trace the wind. The rapid stochastic changes of the yaw control error signal caused by the actual stochastic variations of wind direction and by the accuracy of the yaw control error determination method are suppressed by the smoothing filter so as to match the wind direction variations speed with the possibilities of the wind turbine yaw actuator.

Based on the experience of the similar wind turbines operation, the cut-off frequency of the low pass filter 13 can range from 5.5·10⁻³ Hz to 8.3·10⁻³ Hz and yaw actuator control module 14 can be designed as P controller, PI controller, PID controller, neural-network controller, fuzzy logic controller, adaptive Kalman filter or look-up table.

The given flow chart and its description are intended to explain the inventive matter of the method and do not limit the other embodiments of the method. So, a reference signal and information signals can be generated and processed by the methods of analogue, pulse, or computer engineering. The professionals in this area should face no difficulties in implementing any alterations or improvements to the proposed method, which also fall within the scope of the invention, reflected in the claims.

The wind turbine yaw angle control method according to the present invention can be used both for the newly designed wind turbines and for the retrofitted existing ones.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of controlling a yaw angle of wind turbine, comprising a nacelle (2), rotatable around a vertical axis mounted on a stationary tower (1) and containing a horizontal rotatable rotor shaft (3), a turbine rotor formed by at least two blades (4) mounted on the rotor shaft (3), which transform kinetic energy of the wind into rotational movement of the rotor shaft (3), mechanically connected to an electric generator (5), wherein a signal dependent on the yaw angle of the rotor shaft (3) is processed by a yaw controller (7), and the feedback control signal, which is sent to a yaw actuator (8) in order to compensate the yaw angle error, is built, whereby a control signal transmitted to the yaw actuator (8), is formed based on the time difference between
time moments when the blades (4) are in the lower vertical position, determined by means of the reference signal of a sensor connected to the rotor shaft (3), and
time moments, when the blades (4) are on one line with the wind direction and the stationary tower (1), defined by means of the periodic signal of the spurious amplitude modulation, generated by the electric generator (5) and caused by aerodynamic interaction between the blades (4) and the stationary tower (1).

2. The method as set forth in claim 1, wherein the time moments when the blades (4) are in the lower vertical position are obtained from the vector signal of a rotor position sensor (6), attached to the rotor shaft (3) in the plane perpendicular to the rotor axis and the rotor position sensor (6) being offset relative to the centre of the rotor, and one of the sensitivity axes of the rotor position sensor (6) is aligned with that of the blade (4), from the vector signal of the magnetic encoder equipped with a magnetic scale designed as a ring or strip fixed to the rotor shaft (3), from the vector signal of photo-optic pulse encoder equipped with a transparent disc scale mounted on the rotor shaft (3), from the vector signal of contactless induction proximity of the rotor position sensor (6) and from the vector signal of toothed disc fixed on the rotor shaft (3) or from the vector signal of the system for determining wind turbine rotor blade (4) position by means of wireless signal transmission, the said system including a transmitter mounted on the rotor blade (4) of the wind turbine, a receiver and calculating device for determining position of the rotor a blade (4).

3. The method as set forth in claim 1, wherein a periodic signal of an aerodynamic interaction between the rotor blades (4) and the stationary tower (1) is obtained by
building an envelope of AC current generated by the electric generator (5) by means of amplitude demodulation of the current signal in the vicinity of the grid frequency,
evaluating a period and Fourier coefficients of the obtained envelope periodic component; and
isolating a fundamental harmonic of the aerodynamic interaction between the blades (4) and a signal of the stationary tower (1).

4. The method as set forth in claim 3, wherein the time difference is determined as a difference between the phase of the rotor position sensor (6) reference signal and the phase of the periodic signal of an aerodynamic interaction between the rotor blades (4) and fundamental harmonic of the stationary tower (1).

5. The method as set forth in claim 4, wherein a phase difference signal is low pass filtered before sending it to a yaw actuator control module (14).

6. The method as set forth in claim 5, wherein a filtered time difference signal is sent to the input of the yaw actuator control module (14) designed as P controller, PI controller, PID controller, neural-network controller, fuzzy logic controller, adaptive Kalman filter or look-up table and wherein a control signal is generated for the yaw actuator (8).

7. A wind turbine comprising:
a nacelle (2) mounted on a stationary tower (1) and rotatable around a vertical axis,
a rotor shaft (3) placed in the nacelle (2) and rotatable around a horizontal axis,
a rotor of the wind turbine formed by at least two blades (4) mounted on a hub of the rotor shaft (3), transforming the kinetic energy of the wind into a rotational movement of the rotor shaft (3),
an electric generator (5) mechanically connected to the rotor shaft (3) of the rotor,
a yaw controller (7) with input connected to the a yaw actuator (8), whereby
a sensor (6) of the lower vertical position of the rotor blades (4) reference signal, the sensor (6) being connected to the rotor shaft (3) of the rotor, in that the yaw controller (7) connected to the sensor (6) of the reference signal and to the electric generator (5) generates a control signal from the time difference between the time moments when the blades (4) are in the lower vertical position and the time moments when the blades (4) are on one line with the wind direction and the stationary tower (1) defined by means of the periodic signal of the spurious amplitude modulation, generated by the electric generator (5) and caused by aerodynamic interaction between the blades (4) and the stationary tower (1).

8. The wind turbine of as set forth in claim 7, wherein the yaw controller (7) comprises the following functional units:
a builder (11) of the electric generator (5) output current signal envelope,
a filter (12) of the periodic signal of aerodynamic interaction between the blades (4) and the stationary tower (1) fundamental harmonic, the filter (12) being connected to the output of the builder (11),
a module (9) for processing a reference signal connected to the sensor (6),
a phase meter (10) connected to the outputs of the reference signal processing module (9) and to the outputs of the filter (12) of the periodic signal of aerodynamic interaction between the blades (4) and fundamental harmonic of the stationary tower (1),
a low pass filter (13) for a time difference signal, and
a yaw actuator control module (14) designed as P controller, PI controller, PID controller, neural-network controller, fuzzy logic controller, adaptive Kalman filter or look-up table, the output of the yaw actuator control module (14) connected to a yaw actuator (8), the yaw actuator control module (14) connected to the output of the low pass filter (13).
